(19) United States
(12) Patent Application Publication
(10) Pub. No.: US 2020/0361119 A1
(43) Pub. Date: Nov. 19, 2020

(54) VARIABLE SHAPING FORM

(71) Applicant: The University of Melbourne, Melbourne (AU)

(72) Inventors: Paul Ling Leong Loh, Northcote (AU); David Leggett, Northcote (AU); Daniel Prohasky, Blackburn (AU)

(21) Appl. No.: 16/966,565

(22) PCT Filed: Jan. 31, 2019
(86) PCT No.: PCT/AU2019/050070

§ 371 Date: Jul. 31, 2020

(30) Foreign Application Priority Data
Jan. 31, 2018 (AU) 2018900292

(51) Int. Cl. B28B 7/02; E04G 9/10; B29C 51/20; B28B 1/14; B28B 17/00; B29C 51/46; G05B 19/4093; G05B 19/4099

(52) U.S. Cl. CPC B28B 7/02; E04G 9/10; B29C 51/20; B28B 1/14; B29K 2067/003; B29C 51/46; G05B 19/4093; G05B 19/4099; B28B 17/0081

(57) ABSTRACT

A variable shaping form (10) includes a variable frame (12) and a variable support (16) extending within or across the frame. The shaping form (10) is selectively adjustable to vary the shape of the support (16) to define a variety of differently shaped contours, each of which approximates a doubly-ruled curved surface. The variable frame (12) may be defined by a plurality of frame portions (18, 19, 20, 21).

### FIELD OF THE INVENTION

The present invention relates to a variable shaping form. The variable shaping form may be used to produce shapes, casts or moulded parts. In particular, although not exclusively, the invention relates to a variable shaping form with a frame of variable configuration which approximates a doubly-ruled curved surface. The formed parts may be used for building construction which includes structural and non-structural purposes such as permanent or sacrificial shutters for concrete framework, load bearing blocks, rain screen cladding, landscape pavers and tiling systems.

### BACKGROUND OF THE INVENTION

With the increased use of computation tools in architectural design, architects and designers are increasingly exploring the use of complex curvature surfaces in their designs. Producing bespoke and variable panels allows buildings to be distinctive and increases the perceived value of the asset, particularly for civic or corporate signature buildings and infrastructure projects. However, the realisation of such geometry is often limited by current machinery, method of manufacturing, and cost.

Cost has always been the primary constraint in building projects with complex geometry, especially those with double curvature surfaces, as the tooling process behind the manufacture of such surfaces is often costly for a one-off project. The main tooling cost is the preparation and manufacture of moulds to adequately control the surface deformation of material into the precise form. Both subtractive (CNC milling) and additive (3D printing) procedures for producing double-curved surfaces can often only produce one-off surfaces. In addition to inhibitive costs, current techniques often produce a huge amount of waste and increase the carbon footprint. The Spencer Dock Bridge in Dublin, Ireland is a case study that deployed CNC milling techniques. To produce an undulated doubly curved soffit to the bridge, the formwork was constructed from CNC milled polystyrene (EPS) block sprayed with polyuria. Once the concrete was cured, the formwork was removed and discarded.

In response to the waste produced from such construction techniques, the Irish-Australian based construction company Laing O'Rourke has developed robotic 3D printed re-usable wax moulds called FreeFAB, using an additive procedure to eliminate waste for pre-cast concrete and glass reinforced concrete (GRC) production (Gardiner et al., 2014). The disadvantage of FreeFAB is the investment required for large scale gantry machinery for the robotic arms and the need for unique moulds which add to the set-up time for manufacturing.

Variable parametric moulds have been of research interest in recent years, and a few systems have been put to test in practice (Schipper, 2015), including earlier work by Renzo Piano for free form plastic panels (see FIG. 1). Most variable mould designs are based on single-direction multi-point stretch-forming processes, where actuated pins or armatures define the surface curvature (Wang et al., 2012). There are also other techniques such as incremental sheet forming and flexible roll bending, some of which are still under development (Castaneda et al., 2015).

Other researchers have looked towards deformation processes using robotic manipulator arms (Verma and Epps, 2013). While there is little or no tooling involved, the time to produce individual surfaces adds to the manufacturing time and cost.

Research developed out of Denmark has brought Adapa to the market. Adapa was established in 2010 and utilises a multipoint system for manufacturing double-curved panels. Between January and June 2017, the company launched three different sized machines, aimed at medium to low production for small to medium size manufacturers.

Lee and Kim (2012) outlined several advantages of this procedure, including speed of manufacture and low production cost even for short runs, as demonstrated in the Dongdaemun Design Plaza (DDP) by Zaha Hadid Architects. This building project consists of over 16,000 sq meters of area of double-curve metal cladding surface. Utilising a combination of multipoint forming machines and robotic arm laser cutters, the cost of individual doubly curved panel is reduced from USD$7000 to USD$260 (Lee and Kim, 2012). However, the adaptive mould utilizes a large number of stepper motors to vary the pin height. This adds to complexity and cost.

Therefore, the object of the present invention is to provide apparatus and methods which overcome or at least ameliorate the foregoing disadvantages. Another object of the present invention is to provide a useful choice over known technologies.

Reference to any prior art in the specification is not an acknowledgment or suggestion that this prior art forms part of the common general knowledge in any jurisdiction or that this prior art could reasonably be expected to be understood, regarded as relevant, and/or combined with other pieces of prior art by a skilled person in the art.

### SUMMARY OF THE INVENTION

In accordance with a first aspect of the present invention, there is provided a variable shaping form including:

a variable frame; and

a variable support extending within or across the frame,

wherein the shaping form is selectively adjustable to vary the shape of the support to define a variety of differently shaped contours, each of which approximates a doubly-ruled curved surface.

Each contour (another term might be “topography”) is used to define a moulding, casting or shaping surface. Given that a variety of differently shaped contours may be obtained, the shaping form may be used for the production of differently shaped parts, thereby eliminating wastage which occurs from having a dedicated shaping form for each different shape.

Preferably the shape of the variable support is defined by the shape of the frame. By varying the shape of the variable frame, an infinite number of different geometrical contours may be defined by the variable support. Preferably, only doubly-ruled curved contours are produced by the shaping form.

Preferably, the doubly-ruled curved surface is a hyperbolic paraboloid. Preferably, the variable frame is four-sided and optionally of equal length (rhombus) such that the doubly-ruled curved surface is a rhombus hyperbolic paraboloid.

The variable frame preferably comprises a plurality of frame portions. The frame portions may have any of the following features:
straight rods or bars
fixed i.e. non-variable length
all frame portions are of equal length
4 frame portions
adjacent frame portions are relatively pivotable
adjacent frame portions are either interconnected or discrete i.e. not connected
adjacent frame portions are pivotally interconnected
the ends of adjacent frame portions are pivotally interconnected.

The longitudinal axis through each frame portion preferably intersects with the longitudinal axis through the adjacent frame portion. A multi-axial joint may be provided to interconnect each of the adjacent frame portions. This could be achieved by a ball joint or a tri-axial joint or similar as will be explained.

Suitably, the variable support is able to maintain approximation to a doubly-ruled curved surface throughout the range of potential variation facilitated by the variable frame. The variable support may be in the form of a grid, mesh or grille with the 2 rulings being independent. Such an arrangement may be effected by elastic cords. For example, a series of spaced elastic cords may extend between opposite frame portions. Where there are four frame portions, the cords may extend between both pairs of opposite frame portions to define a grid mesh. In this case, each elastic cord acts as a ruling in the doubly-ruled curved surface.

In a more preferred form of the invention, the variable support is defined by a series of spaced rods or bars extending between opposite frame portions. For example, where the variable frame comprises four frame portions, the series of spaced rods or bars preferably extends between two opposite frame portions with the rods or bars running substantially parallel to each other.

The rods may be more constrained at one of the two frame portions than the other frame portion. For example, at the first frame portion, the rod may interconnect with the frame member by means of a spherical joint, for example at the end of the rod. This spherical joint may provide three degrees of freedom. At the second opposite frame portion where the rod is less constrained, the rod may pass through a slot with adequate clearance to permit the same degrees of freedom as with the first frame portion as well as sliding movement of the rod relative to the second frame portion (four degrees of freedom).

In the series of rods, one rod may be fixed to both opposite frame portions to maintain the orientation of the opposite frame portions relative to the series of rods to prevent unintended contact therebetween. For example, that rod may be constrained against pivoting about an axis substantially aligned with the longitudinal axis of the associated frame portion. The end of the rod may be pinned to the frame portion to permit pivoting about a transverse axis through the frame portion. Preferably, the central rod in the series of rods is so pinned at both ends.

In accordance with a second aspect of the present invention, there is provided a variable shaping form including:

a variable frame defined by a plurality of frame portions; and

a variable support extending within or across the frame,

wherein the frame portions are selectively relatively moveable to vary the shape of the support to define a variety of differently shaped contours.

Any of the features described above in connection with the first aspect of the invention may have application to this aspect of the invention.

In accordance with another aspect of the present invention, there is provided a method of shaping formable material, the method including:
a) providing a variable shaping form as per either the first or second aspects of the invention;
b) adjusting the variable shaping form such that the variable support defines a desired contour;
c) either before or after step b, supporting the formable material on the variable support;
d) allowing the formable material to fully or partially set or curve to substantially conform to the desired contour of the variable support; and
e) removing the formable material from the variable shaping form.

The method may further include a batch process of repeating steps b) to e) with the same selected contour or a different selected contour.

The method may further include adjusting the variable frame to obtain the desired contour.

The method may be used for the shaping of pre-formed sheet material. The method may also be used for thermal forming techniques. For example, thermo-formed plastics such as thermo-formed PET plastic may be shaped by heating the plastic sheet and supporting it by the support within the frame (the heating may be a preliminary step). The raw material may rest directly against the variable support, either above or below the support, or be provided with a flexible auxiliary support e.g. a mould which adopts the shape of the variable support.

Alternatively, the method may be used for casting or moulding of materials such as concrete. In this context, a flexible mould may be provided which is supported on the variable support, for example, the flexible mould may be a silicon mould.

Typically, curved panels are produced from the variable shaping form, most preferably in the shape of rhombi hyperbolic paraboloid. Where a panel is required to have a non-equal edge length, the panel may be trimmed using a robotic manipulator arm. In any case, post-processing of the formed panels may be carried out robotically. The panels may have flat sides allowing butt-joining of the panels.

In accordance with yet another aspect of the present invention there is provided a forming apparatus including:

a variable shaping form as set out in above in connection with either the first or second aspects of the invention;

a support apparatus to adjust the variable shaping form.

The support apparatus may include mechanisms for adjusting the variable frame to retain approximation to the doubly-ruled curved surface. Preferably this includes a motorised adjustment mechanism. The adjustment of the variable frame may be driven from the vertices of the frame. There may be one adjustment actuator for each vertex. However, adjustment actuators need not be positioned at the vertices.

The geometric model of the rhombus hyperbolic paraboloid panel with constant side lengths, may be described as the change in geometry from a flat square in the xy plane. Diagonally opposite first vertices may be coplanar on the xz plane (Vertices V″₀, V″₂) and diagonally opposite second vertices may be coplanar on the yz plane (Vertices V″₁,V″₃). The rhombi hyperbolic paraboloid panel shapes can therefore be defined by a change in geometry from the flat square.

Thus, the parametric descriptors for any shape approximating the rhombus hyperbolic paraboloid are:

Skew (α): the skew from a perfect square i.e. stretched along the x-axis and consequently shrunk along the y-axis, or stretched along the y-axis and consequently shrunk along the x-axis;

Beta (β): the fold angle about the x-axis of the rotationally translated second vertices (Vertices V″₁, V″₃).

The panel geometry is generally within the frame so each of the first vertices (V″₀, V″₂) of the panel have a corresponding first frame vertex (V^{f}₀, V^{f}₂) and likewise each of the second vertices (V″₁, V″₃) of the panel have a corresponding second frame vertex V^{f}₁, V^{f}₃. The first frame vertices are associated with respective actuators (a actuators) to adjust skew while the second frame vertices are associated with respective actuators (β actuators) to adjust beta. In other words, one actuator is associated with each vertex of the frame.

Preferably the actuators are numerically controlled linear actuators.

Each β actuator may be connected to the associated vertex in a manner which allows for intersection of the longitudinal axis of the actuator and two adjacent frame portions at a single point. This is the “tri-axial joint” which provides pivotal interconnection between two adjacent frame portions and the associated actuator. The β actuator preferable extends approximately vertical with the tri-axial joint uppermost. The other end of each β actuator may be mounted for pivotal movement about two axes lying in a plane transverse to the longitudinal axis of the β actuator (the two degrees of freedom being pitch and roll). Yaw/torsional movement is constrained. The tri-axial joint is merely preferred and axial crossings which do not meet at a single point are also within the scope of the invention.

The longitudinal axis of each α actuator is preferably inclined relative to the x axis. The α actuators may have opposite angles of inclination, preferably rising away from each other. Ramps may be provided to define the angle of inclination.

Any of the features described in the foregoing aspects may be applied to this aspect of the invention.

In accordance with yet another aspect of the present invention, there is provided, a preparatory method in the construction of a free form surface, the method comprising:

a) converting a descriptive geometric model of the free form surface into panel data indicative of a plurality of panel components; and

b) converting the panel data into configuration data representative of the configuration of a variable shaping form required to produce each of the panel components.

The variable shaping form may be of the type described in connection with any aspect above. Moreover, the variable shaping form may be incorporated into a forming apparatus, in particular a CNC forming apparatus.

The method may further comprise outputting the configuration data. Additionally the method may include converting the configuration data into CNC code which is output to the CNC forming apparatus.

In step a), the panel data may be indicative of a doubly ruled curved surface, preferably a hyperbolic paraboloid, most preferably of equal side length. The panel data for each panel having four reference points or vertices may include panel skew (α) and fold angle (β) of diagonally opposite second vertices or reference points about an axis through diagonally opposite first vertices or reference points. The panel data may be converted to determine the vertices or reference points of each panel.

In step b), the vertices or reference points of each desired panel may be extrapolated onto the vertices of a frame of the variable shaping form used to shape the apparatus. The frame may have any of the features described above in connection with foregoing aspects of the invention.

The extrapolation may use initial estimates of the frame vertices, with the error resulting from the estimates being used to solve a correction function as part of a process to determine the vertices of the frame. This can be done using 3 estimates of the frame vertices to solve a quadratic correction function.

In short, the parabolas extending between diagonally opposite vertices or reference points of the panel are extrapolated to estimate the location of the frame vertices, with the error resulting from the estimates being used to solve a correction function to determine the vertices of the frame.

More particularly, the initial estimates of the frame vertices may be extrapolated from a first surface parabola extending between a first pair of diagonally opposite vertices. Preferably, a spherical intersection between firstly, a sphere centred at each estimated frame vertex, and secondly, a second parabola extending between a second pair of diagonally opposite vertices is used to determine secondary estimates of the frame vertices. The primary and secondary estimates define corresponding virtual frames, each having an estimated centre which is offset from the panel centre CP. A correction function which relates the offset to the abscissa of each initial estimate is used to solve for the abscissa of the vertex of one of the first pair of diagonally opposite vertices. A similar process may be used to solve for the second part of diagonally opposite vertices.

In order to place the frame in the correct orientation, the target travel distances α_{action} and β_{action} of the frame vertices from a known starting point can be calculated from the solved frame vertices. The control signal or numerical output to the α and β actuators is derived directly from α_{action} and β_{action}.

In accordance with yet another aspect of the present invention, there is provided, a preparatory method for the construction of panels to be formed on a variable shaping form by the use of a variable frame, the method comprising:

converting panel data representative of the panels into configuration data representative of the configuration of the variable shaping form, wherein the panel data includes data indicative of the vertices of the panel and in converting the panel data, the vertices of each desired panel are extrapolated to define estimated vertices for the variable frame, with any error resulting from the estimates being used to solve a correction function as part of a process to determine the vertices of the frame.

This can be done using 3 estimates of each vertex to solve a quadratic correction function. Any of the features described in the forgoing aspects may have application to the present aspect.

In accordance with a final aspect of the present invention, there is provided, a preparatory method in the construction of a free form surface, the method comprising:

converting a descriptive geometric model of the free form surface into panel data indicative of a plurality of panel components wherein the panel data for each panel having four reference points or vertices includes: panel skew (α); and fold angle (β) of diagonally opposite second reference points or vertices about an axis through diagonally opposite first reference points or vertices.

As used herein, except where the context requires otherwise, the term “comprise” and variations of the term, such as “comprising”, “comprises” and “comprised”, are not intended to exclude further additives, components, integers or steps.

Further aspects of the present invention and further embodiments of the aspects described in the preceding paragraphs will become apparent from the following description, given by way of example and with reference to the accompanying drawings.

### BRIEF DESCRIPTION OF THE DRAWINGS

In order that the invention may be more fully understood, one embodiment will now be described, by way of example, with reference to the figures in which:

FIG. 1 is a perspective view of a forming apparatus in accordance with a preferred embodiment of the present invention;

FIG. 2 is a perspective view of the forming apparatus shown in FIG. 1, except illustrating a second configuration of the apparatus;

FIG. 3 is a perspective view of the forming apparatus shown in FIG. 1, except showing the apparatus in a third configuration;

FIG. 4A is a perspective view from above of the forming apparatus illustrated in FIG. 1;

FIG. 4B is a detailed view of the forming apparatus illustrated in FIG. 4A;

FIG. 5A is a perspective view of one of the β actuators forming part of the forming apparatus illustrated in FIG. 1;

FIG. 5B is a side elevation of the β actuator of FIG. 5A;

FIG. 5C is an end elevation of the β actuator of FIG. 5A;

FIG. 6 is an exploded view of the β actuator shown in FIG. 5;

FIG. 7 is a perspective view illustrating one of the α actuators forming part of the apparatus of FIG. 1;

FIG. 8 is an exploded view of the α actuator illustrated in FIG. 7;

FIG. 9 is a side elevation of the α actuator illustrated in FIG. 7;

FIG. 10 is an end elevation of the α actuator illustrated in FIG. 7;

FIG. 11 is a flow chart of the process from the geometry of a desired free form surface to moving the apparatus into the forming apparatus into a required forming configuration;

FIG. 12 is a descriptive geometry model showing translation of physical parametric model into trajectories of motion;

FIG. 13 is a panelised wall free from surface (right) and geometry generated using Kangaroo Physics (left);

FIG. 14 is descriptive parameters of symmetric hyperbolic paraboloid panels;

FIG. 15A is descriptive geometry showing translation of symmetric hyperbolic paraboloid panel to position of mould frame vertices;

FIG. 15B is a diagram showing limits of current machine (left) and a diagram showing asymmetrical panel trimmed from symmetrical panel (right);

FIG. 16 is a diagram of a square;

FIG. 17 is the square of FIG. 16 when skewed;

FIG. 18 is a diagram of the Cartesian axes for the skewed square of FIG. 17;

FIG. 19 is a diagram of the skewed square with β rotation;

FIG. 20 is a diagram of the hyperbolic paraboloid with rulings;

FIG. 21 is a diagram of curvature matching;

FIG. 22 is a diagram of parabolas describing the curvature of the hyperbolic paraboloid surface;

FIG. 23 is a diagram showing three estimates of the frame vertices;

FIG. 24 is a diagram of the distance between the centre point of the panel and one of the three estimated frames;

FIG. 25 is a diagram of the solution for the abscissa of the frame vertex;

FIG. 26 is a diagram of the required centre point correction; and

FIG. 27 is a diagram of a computer system upon which one or more of the various steps may be performed.

### DETAILED DESCRIPTION OF THE EMBODIMENTS

### 1 Forming Apparatus

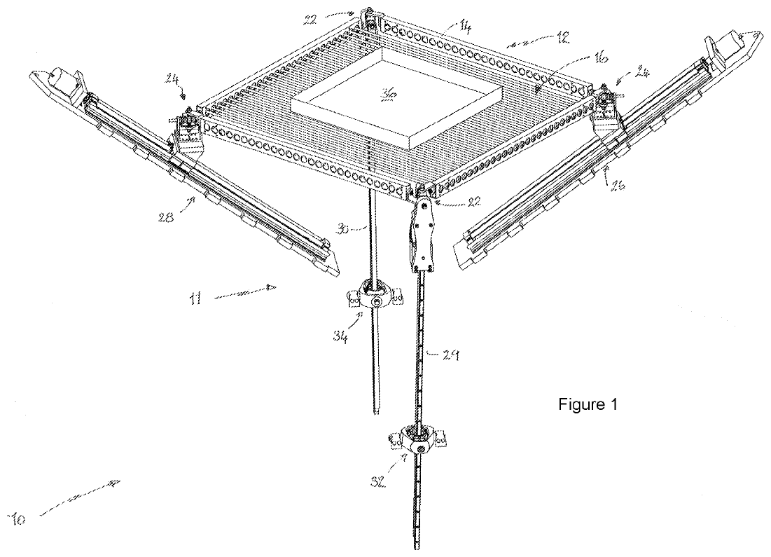

FIG. 1 illustrates a forming apparatus 10 according to a preferred embodiment. The forming apparatus 10 includes a variable shaping form 12 which is comprised of a variable frame 14 and a variable support 16 extending across the frame 14.

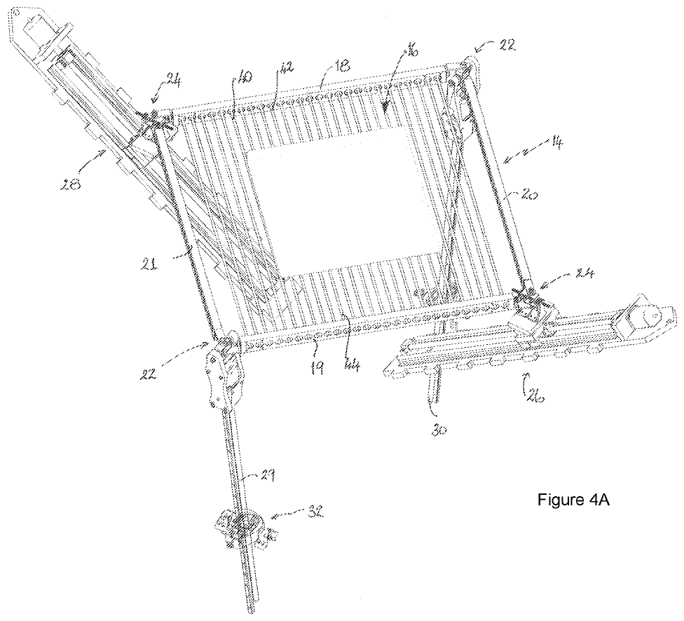

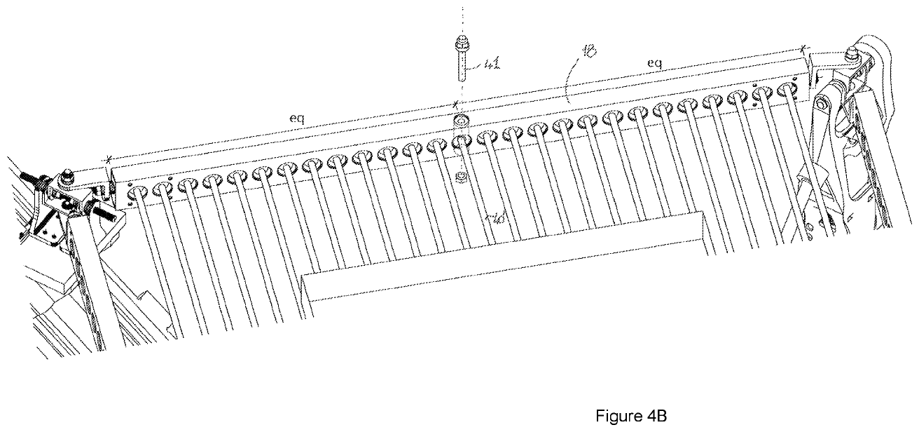

The frame 14 is comprised of four frame portions 18, 19, 20, and 21 (see FIG. 4). The frame portions 18 and 19 are opposite each other, while frame portions 20 and 21 are opposite each other. Each frame portion 18, 19, 20 and 21 is pivotally interconnected to the adjacent frame portion at a joint 22, 24 as will be explained subsequently. Diagonally opposite corners of the frame 14 define first frame vertices (V^{f}₀, V^{f}₂) at the centre of the joint 24. The position of the first frame vertices is determined by the position of the α actuators 26, 28.

The other diagonally opposite corners of the variable frame 14 define second frame vertices V^{f}₁, V^{f}₃ at the centre of the tri-axial joint 22. The position of the second frame vertices is determined by respective β actuators 29, 30 and the position of the first frame vertices.

Both the α actuators 26, 28 and the β actuators 29, 30 are linear actuators. However, the α actuators 26, 28 are of a different form than the β actuators 29, 30 as will be explained.

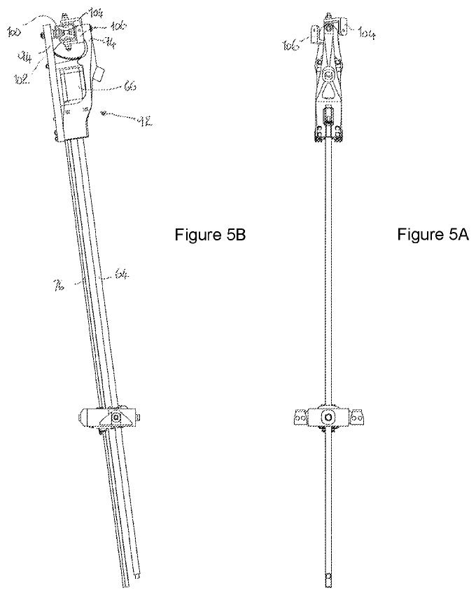

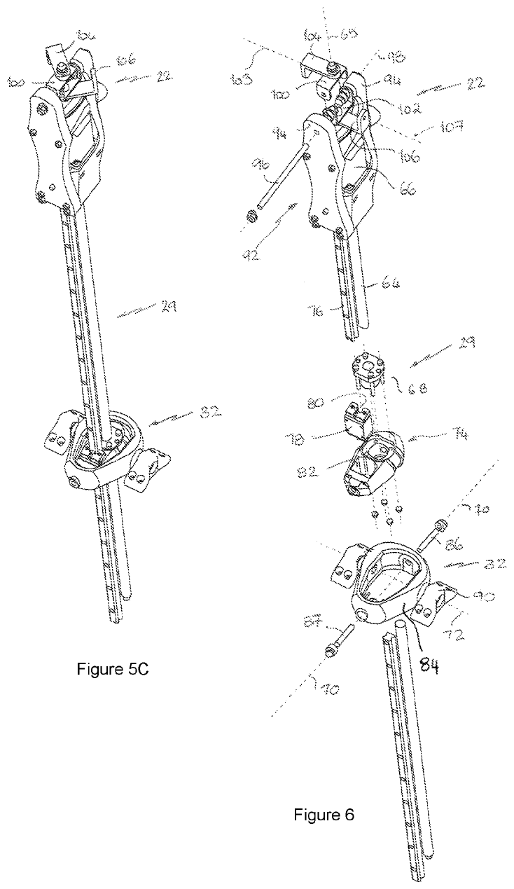

The forming apparatus 10 is arranged with the variable form 12 and variable support 16 in a substantially level configuration. However, this will vary as the shape of the variable form is changed to suit different moulding requirements. With the variable frame 14 configured as a flat square at a rest position, the variable support 16 will be substantially horizontal. In this configuration of the forming apparatus 10, the 13 actuators 29, 30 are arranged in a substantially upright configuration. The α actuators 26, 28 have their longitudinal axes oppositely inclined. The α actuators extend upwardly in the direction away from the centre of the variable support 12. The α actuators 26, 28 are supported in this ramped orientation by means of support ramps forming part of a support substrate (not shown). The β actuators 29, 30 are also mounted to the support substrate by means of the bi-axial joints 32, 34 as will be explained subsequent in connection with FIGS. 5 and 6.

The inclination of the α actuators 26, 28 exists to prevent collision of the joints 24 against the frame 14. The precise angle of the slope is not important but the gradient employed here is 4 across by 3 up.

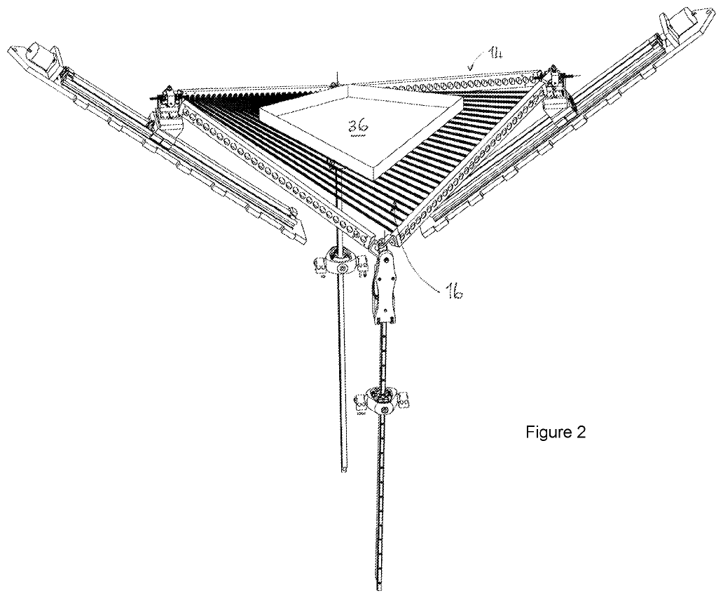

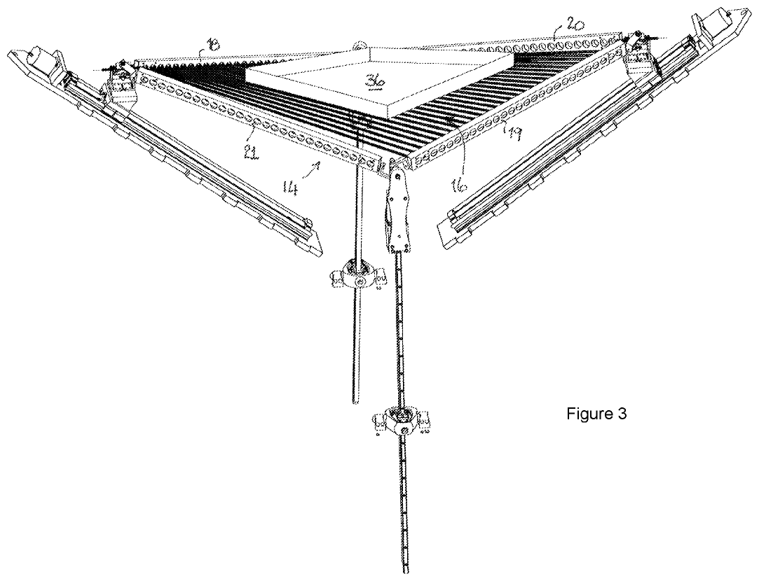

The variable frame 14 is movable into a number of configurations by support apparatus 11. The variable frame 14 is configured to vary the support 16 to define any number of differently shaped contours, each of which approximates a doubly-ruled curved surface. Thus, the curved surface 16 can be used as a form to mould or shape formable material. In one preferred embodiment, the preferred material is concrete and thus, a silicon tray 36 is provided to contain the concrete. The tray 36 is flexible and thus conforms to the shape of the support 16. Thus, the shape of the moulded concrete panel (not shown) when set will substantially conform to the shape of the variable support 16. Therefore, by changing the shape of the variable support 16, a variety of differently shaped contours may be achieved and thus differently shaped parts or panels may be created using the same apparatus, thereby eliminating wastage.

Whereas FIG. 1 illustrates the variable frame in the level square configuration, FIG. 2 illustrates a second configuration providing a second shape contour on the support 16 following the necessary movement of the actuators. FIG. 3 illustrates a third configuration of the apparatus which creates a third configuration of the variable form to define a third contour on the support 16.

1.1 Variable Frame

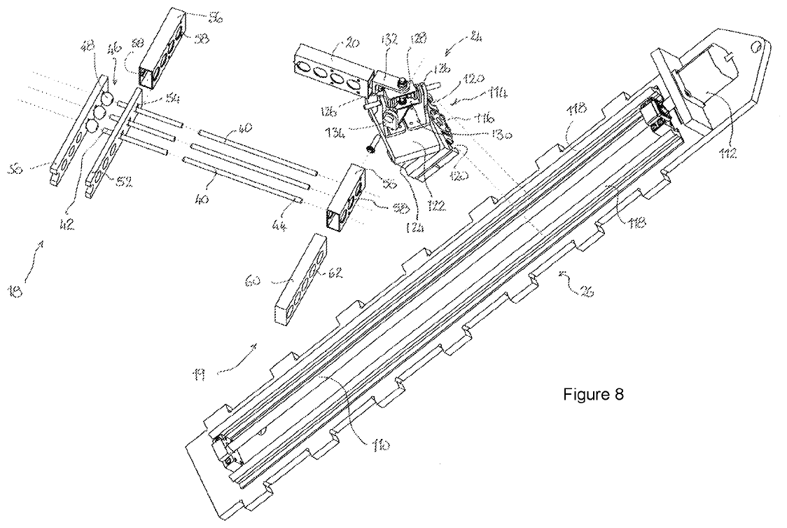

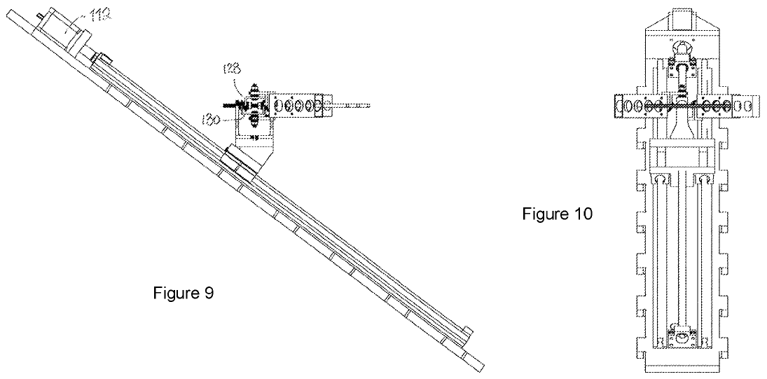

FIGS. 4A, 4B and 8 illustrate the structure of the variable frame 14 in greater detail. As mentioned, the variable frame 14 comprises four frame portions, 18, 19, 20, 21 which are of equal length and are pivotally interconnected by means of tri-axial joints 22 at the diagonally opposite second vertices and second joints 24 at the diagonally opposite first vertices. The frame portions 18, 19 are spaced across from each other on opposite sides of the frame 14. Extending between the frame portions 18, 19 is a series of parallel spaced rods 40. This series of spaced parallel rods 40 makes up the variable support 16. The rods 40 move relative to the frame portions 18, 19 through the range of permitted movement of the variable frame. One end 42 of each of the rods 40 is constrained more than the other end 44.

As shown in FIG. 8, each end 42 is mounted to the frame portion 18 by means of a spherical joint 46 which comprises a ball 48 threadingly engaged at the end of the rod 42. Each ball 48 is captured between two plates 50, 52 which seat the ball therebetween and allow for three degrees of freedom (rotation about 2 axes and rotation about the longitudinal axis of the rod 40). The plates 50, 52 have inwardly facing spherical seats to seat the ball 48. Additionally, plate 52 has a circular hole 54 permitting passage of the rod 40 therethrough. The two plates 50, 52 are housed within a sleeve 56 having a series of circular holes 58 on both side walls of the sleeve 56. The series of holes 58 in each side wall align with each other and with the balls 48 and rods 40. Each rod 40 extends through a corresponding set of aligned holes 54, 58.

At the other end of the rods 44, the frame member is made up of an identical sleeve 56 with a series of spaced holes 58. An insert 60 is received within the sleeve 56. The insert 60 comprises a series of spaced holes 62 which align with the holes 58. The arrangement of holes 62 in the frame member 19 is such to permit a greater degree of freedom for the second end 44 of the rod 40 compared to the first end 42. Each end 44 is permitted to pivot about two axes, rotate about the longitudinal axis and translate along the longitudinal axis of the rod 40 (4 degrees of freedom). Thus, the second end 44 of the rod is less constrained than the first end 42.

Additionally, as shown in FIG. 4B the centre rod 40′ is more constrained compared to the other rods 40. Each end of the centre rod 40′ is pinned by a pin 41 which extends through an axis transverse to the longitudinal axis of the frame portion 18, 19. This allows the rod 40′ to pivot about an axis aligned with the centre of the pin 41. Given that the arrangement of the spherical joints 46 and the joints 22, 24 will permit the frame portions 18, 19 to pivot relative to the rods 40, the pinning of the central rod 40′ constrains the relative movement to limit potential interference between the frame portions 18, 19 and the rods 40.

The frame portions 20 and 21 may be in a similar form to frame portion 19, with or without the insert 60.

1.2 β Actuator

FIGS. 5 and 6 show the form of the β actuator 29. The β actuator 30 is substantially the same.

The β actuator 29 is in the form of a linear actuator with a threaded drive rod 64 driven by stepper motor 66. The drive rod 64 is driven to rotate about its longitudinal axis. The drive rod 64 is externally threaded and engages with an internally threaded mount 68. The mount 68 is supported at a fixed level in the bi-axial joint 32 mounted on the fixed support structure (not shown). The mount 68 is also constrained against rotation about the longitudinal axis of the drive rod within the bi-axial joint 32. Thus, rotation of the drive rod 64 by the stepper motor 66 will cause the drive rod 64 to move either up or down relative to the support structure, depending upon the direction of rotation of the drive rod 64. Thus, the second vertex of the two adjacent frame portions 19, 21 which is located at the tri-axial joint 22, will be driven up and down.

The mount 68 is mounted in the bi-axial joint 32 for rotation about two axes 70, 72 which lie substantially parallel to the plane of the support structure on which the bi-axial (gimbal) joint 32 is mounted. The mount 68 is received within a complementary recess in a hub 74. The mount 68 is attached to the hub 74 by screw fasteners.

A guide rod 76 extends alongside the drive rod 64 in a parallel and spaced manner. The guide rod 76 is received within a slide block 78. The slide block 78 has a keyway 80 having a complementary profile to the guide rod 76. As the drive rod 64 is driven up and down relative to the mount 68, the guide rod 76 slides within the keyway 80 to guide the motion. The slide block 78 is received within a complementary recess 82 in the hub 74.

The hub 74 is mounted within an annulus 84 which surrounds the hub 74. The hub 74 is pivotable about axis 70 by means of a pin connection between the hub 74 and the annulus 84 by means of pins 86 and 87.

The annulus 84 is mounted between two trunnions 90 and is thereby pivotable about axis 72. Axes 70 and 72 extend transversely to each other. The bi-axial (gimbal) joint 32 minimises the constraint imposed by the connection of the β actuator 29 to the support structure.

If the support structure is a table then the lower ends of the drive rod 64 and the guide rod 76 extend through a hole or aperture in the table.

At the upper end of the β actuator, the tri-axial joint 22 joins the β actuator 29 to the frame portions 19 and 21. At the upper end of the drive and guide rods 64, 76, is an actuator bracket 92 which houses the stepper motor 66. The actuator bracket 92 defines two spaced trunnion arms 94. A pin 96 extends between the trunnion arms 94 to define a first pivot axis 98.

Pivotally mounted to rotate about the pivot axis 98 defined by the pin 96 is a first inverted U-shaped bracket 100. A second U-shaped bracket 102 is also pivotally mounted for rotation about the pivot axis 98 by the pin 96. The U-shaped bracket 102 is offset from the location of the U-shaped bracket 100. An L-shaped bracket 104 is pivotally connected to the inverted U-shaped bracket 100. The downwardly turned leg of the L-shaped bracket 104 is pivotally connected to the frame portion 21 for pivotal movement of the frame portion 21 about the longitudinal axis of the frame portion 21. The L-shaped bracket 104 pivots relative to the inverted U-shaped bracket 100 through an axis which is aligned with the longitudinal axis of the drive rods 64.

The U-shaped bracket 102 is pivotally attached to a second L-shaped bracket 106. The pivotal axis is also aligned with the longitudinal axis of the drive rods 64. The upturned end of the L-shaped bracket 106 is pivotally connected to the frame portion 19 for relative pivotal movement about the longitudinal axis of the frame portion 19. The configuration of the tri-axial joint 22 is such that the longitudinal axis 65 of the drive rod 64, the longitudinal axis 103 of the frame portion 21 and the longitudinal axis 107 of the frame portion 19 intersect at a single point. The tri-axial joint 22 is considered superior to a ball joint.

1.3 α Actuator

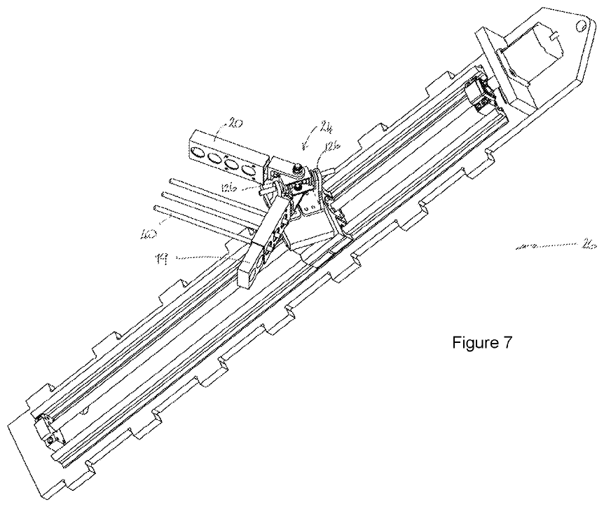

FIGS. 7 and 8 illustrate the form of the α actuator 26. The α actuator 28 is a mirror image of the α actuator 26.

The α actuator 26 includes a drive rod 110 driven by stepper motor 112 to rotate in either direction. A carriage 114 is driven by the drive rod 110 up and down the incline. The carriage 114 includes an internally threaded mount 116 which interacts with the drive rod 110 in a similar manner as described above for the β actuator 29. Two spaced parallel guide tracks 118 are provided on either side of the drive rod 110 in spaced parallel orientation. The guide tracks 118 are complementary to keyways 120 provided in the carriage 114 enabling the carriage to slide up and down the guide tracks 118.

A mounting plate 122 is provided on top of the carriage 114 and is angled relative to the inclination by a wedge 124. The wedge 124 has an upper surface with the complementary angle of inclination of the ramped actuator to present the mounting plate 122 at substantially horizontal orientation.

The joint 24 is mounted on the mounting plate 122 and includes two spaced trunnions extending upwardly from the mounting plate 122 and defining an axis for rotation for the inverted U-shaped bracket 128 and the offset U-shaped bracket 130. The inverted u-shaped bracket 128 is connected to the frame portion 20 by means of an L-shaped bracket 132. The U-shaped bracket 130 is connected to the frame portion 19 by means of a similar L-shaped bracket 134. The longitudinal axes of the frame portions 19, 20 intersect at a single point within joint 24.

### 2 Operation of Forming Apparatus

The operation of the forming apparatus will now be described. A control system (not shown) generates the control signals for the α and β actuator 26, 28, 29 and 30 to drive the vertices of the variable frame 14 to the desired position. This will cause the variable support 16 to adopt the desired contour approximating a doubly-ruled curved surface. Concrete is then poured into a silicon tray 36 supported on the variable surface 16. The concrete is leveled and partially set prior to the support 16 being moved to adopt the desired contour. Because of the flexible nature of the silicon tray 36, the silicon tray will adopt contour of the support 16. Once set, the silicon tray 36 is removed from the support 16. The concrete panel can then be removed from the silicon tray 36 and the tray re-used. GRC concrete mix enables casting of a thin concrete shell. Calcium sulfoaluminate (CSA) added to the concrete mix will allow the mix to achieve early strength and permit the panel to be moved within 15 minutes and demoulded within 5 to 6 hours.

The silicon tray 36 may be of any perimeter shape and any size provided within the boundaries of the frame 14 and need not be straight-sided. For example, where the perimeter shape is irregular and therefore not a quadrilateral, a four-sided or rhombus hyperbolic paraboloid (RHP) may be defined within the perimeter shape and thus within the panel. The vertices of the RHP serve as reference points to determine the frame vertices for the frame configuration 14 required to obtain that RHP within the perimeter of the mould, while the perimeter shape is obtained from the mould perimeter. In any case, any panel whether four-sided or not may be defined by reference to an RHP within or extrapolated from the panel shape and thus defined by reference points instead of its vertices.

FIG. 2 shows how a second shape may be obtained using the same forming apparatus. While FIG. 3 illustrates how a third shape may be achieved by the same forming apparatus. Thus, this invention eliminates the need to produce individual moulds for doubly-ruled curved panels through a single variable mould apparatus 10 which is computer numerically controlled, thereby reducing cost and waste in the production cycle.

### 3 from CAD Model to Control Signals

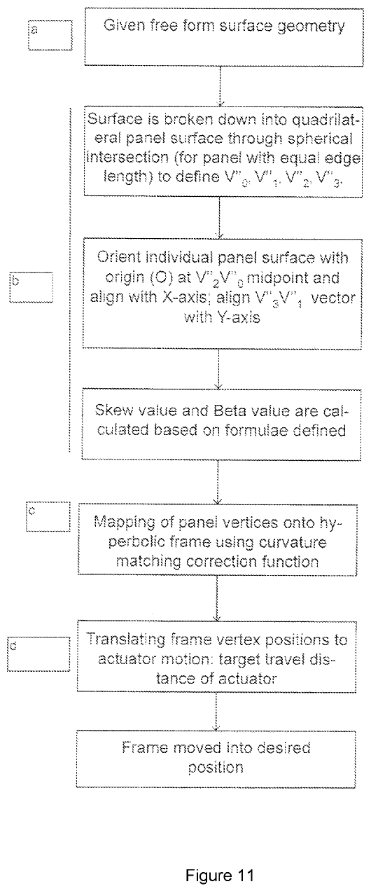

FIG. 11 illustrates the steps to produce the control signals or numerical outputs for the α and β actuators to achieve a desired panel geometry, starting with a desired free form surface geometry. Firstly, the descriptive geometry of the panels will be explained.

3.1 Descriptive Geometry of the Panel

The panels are a hyperbolic paraboloid with quadrilateral boundaries of equal length, otherwise known as rhombi. Thus their diagonals intersect at right angles. The transformation of the panel surface between its potential forms can be understood as follows: the trajectory at opposing corners of the panel edge is the intersection of two spheres (radius=edge length), where the centre is based on the remaining two corners of the panel (see FIG. 12).

The model of the hyperbolic paraboloid panel surface has three parameters: (A) an edge length (predetermined and constant), and two parameters measured as a change in geometry from a flat square lying on the xy plane: (B) the skew (α or alpha) relative to the perfect square; and (C) a change of angle in degrees (β or Beta) about the x-axis. The change in skew resulting in a change along the y-axis results in the change of angle about the X-axis (change in β), provided the panel edge lengths are all equal.

3.2 Summary of Steps from CAD Model to Control Signals

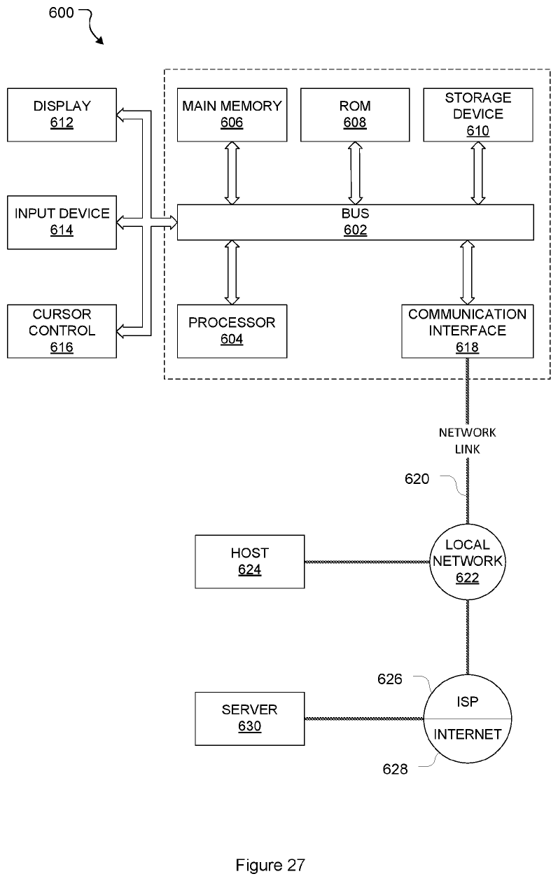

The goal of the following description is to take a geometric model of a free form surface which is desired to be constructed and break it down into individual panels that can be moulded using the forming apparatus 10, then, knowing the desired individual panel geometry, ultimately calculate the numerical outputs to the α and β actuators of the forming apparatus 10. More particularly, this is achieved by the following steps with reference to FIG. 11:
(a) Obtain CAD model of a free form surface.
(b)(i) Break the free form surface into hyperbolic paraboloid panels of equal side length and determine the vertices of such panels.
(b)(ii) Orient individual panels to X and Y axes as illustrated in FIG. 12.
(b)(iii) Once the vertices of a desired panel are known, calculate alpha and beta for the panel. The variety of different contours achievable by the variable frame 14 can also be described by corresponding descriptors alpha′ and beta′. Thus, it is desired to map alpha and beta of the panels onto alpha′ and beta′ of the frame 14. However, the translation of alpha and beta to alpha′ and beta′ is without a deterministic solution.
(c) Instead, map the vertices of the desired panel onto the vertices of the frame using initial estimates of the frame vertices, with the error resulting from the estimates being used in the process to solve for the correct vertices of the frame. This can be done using 3 estimates of the vertices to solve a quadratic correction function.
(d) Now having the vertices of the frame which are required to make the desired panel, the target travel distances α_{action} and β_{action} of the frame vertices from a known starting point can be calculated. The control signal or numerical output to the α and β actuators is derived directly from α_{action} and β_{action}. The methods and techniques described here may be implemented on one or more special purpose computing devices as defined below in the “Hardware Overview” in connection with FIG. 27, with the various different steps and even sub-steps above performed on the same special purpose computing devices, on linked special purpose computing devices or special purpose computing devices linked with a control system of the apparatus 10, such as an NC numerical control.
For example, the CAD model may be developed on a desktop computer system. Step (b)(i) may be performed on the same desktop computer in the same or another software module. Optionally steps (b)(ii) and (b)(iii) may be performed on the same desktop computer in another software module. Preferably the software module for steps (b)(ii) and (b)(iii) is discrete from the module for the preceding steps.
The output of (b)(iii) (alpha and beta) may be then transferred to another special purpose computing device or another software module on the same desktop computer in order to perform step (c) to obtain the frame vertices. Alternatively steps (c) and steps (b)(ii) and (b)(iii) may be combined.
Step (d) may be performed on the same or another special purpose computing device as step (c) to obtain α_{action} and β_{action} for the frame movements. Preferably, the output of step (d) may be the input to the control system of the apparatus 10. However, the control system may incorporate steps (c) and (d) on receipt of alpha and beta for the panel. Other combinations of these arrangements may also be implemented. Such special purpose computing devices may be networked as set out in the example of FIG. 27 below.
The control system may be incorporated into or associated with the forming apparatus 10. Thus, alpha and beta (the minimum descriptive information of the panels) may be communicated between modules and converted back to panel vertex information as required.

3.3 Step (b)(i) Panelise a Desired Free Form Surface

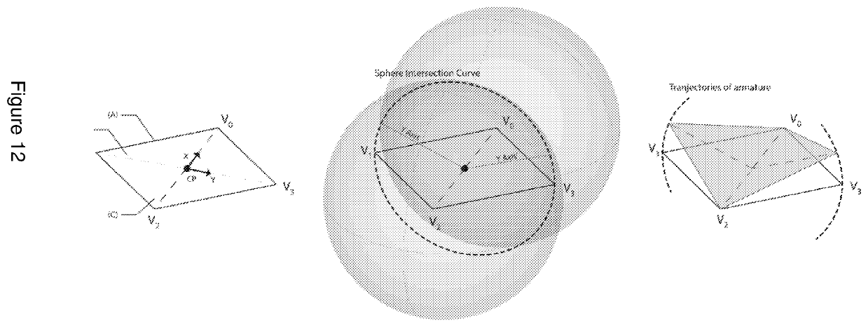

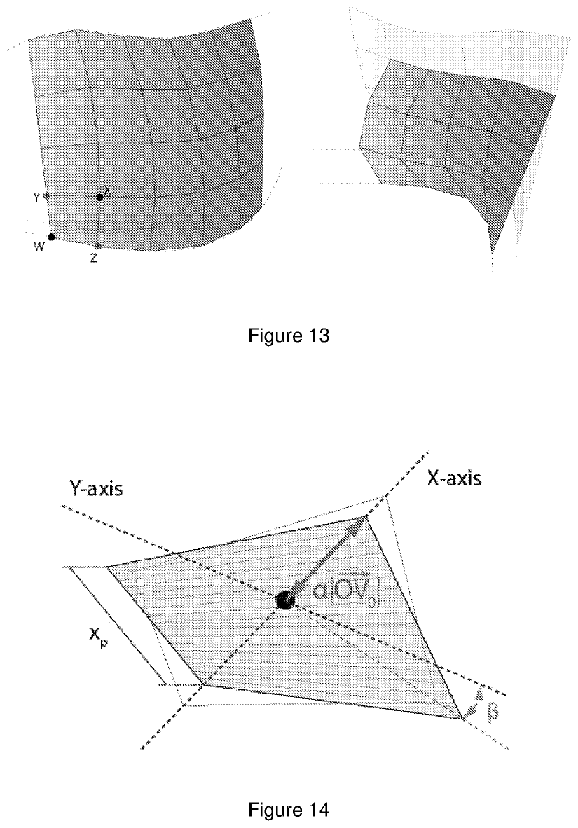

We can take most freeform curve surfaces, e.g. modelled in CAD or any other mathematical model of a freeform surface and panelise them. Taking one corner of the freeform surface as a starting point (point W illustrated in FIG. 13), we can iterate the process using custom script in McNeel Rhinoceros, with Grasshopper v0.9.0076 to find the intersection of equal edge lengths on the surface (point Y & Z followed by point X). These known points (W, Z, X and Y) are thus the vertices (V″₀, V″₁, V″₂, V″₃) of the panel in the mathematical model of the panel discussed below.

3.4 Steps (b)(ii) and b(iii)

Before moving to the subsequent steps, a little more description of the mathematical model of the panel is provided.

Mathematical Modelling

A. Detailed Description of Mathematical Model of the Panel

The resulting rhombi hyperbolic paraboloid panels require tensor (self-referencing) parametric descriptors. The most intuitive and minimal number of parameters are used: ‘skew’ and ‘beta’ (FIG. 14).

Skew (or α) is a ratio which describes the amount by which the quadrilateral is skewed from a perfect square. A skew of greater than one means the panel is stretched along the x-axis (and subsequently contracted through the y-axis) and vice versa for a skew of less than one.

Beta (or β) is the fold angle about the x-axis (of the rotationally translated vertices which correspond to the y-axis).

The panel surface geometry can be regenerated from the two parametric descriptors if required (an edge length must also be specified—though this is predefined and unaltered for a set of panels).

The two chosen parametric descriptors (skew and beta) intuitively correspond to the actual frame geometry of the forming apparatus 10 and the mechanical movement of the α and β actuators required to achieve the desired frame geometry. The two α linear actuators 26, 28 control the amount of skew and the other two β linear actuators 29, 30 control the degree of beta rotation. All four actuators can move independently of one another within the physical bounds of the apparatus 10. This drastically simplifies the mechanical drive routine.

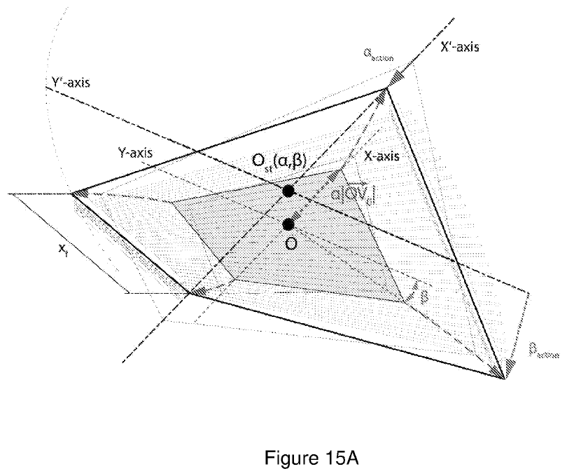

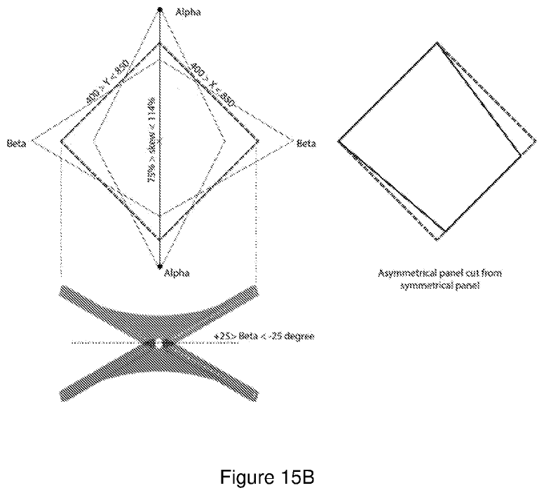

The main challenge (as discussed in (b)(iii) above) within the mathematical model for the apparatus 10 is the translation of the panel geometry (defined as alpha and beta) to the frame geometry (defined as alpha′ and beta′) and thence to the necessary actuator actions (α_{action}, β_{action}). See FIG. 15A.

The translation functions from the panel geometry (alpha and beta) to frame geometry (alpha′ and beta′) are indeterminate. Instead, a method using a quadratic convergence function solver is used to map the panel vertices onto the frame vertices (step c)).

Firstly, the determination of alpha and beta within the context of the mathematical model for the panel is discussed.

B. Initial Note about Step (c) Mapping of Panel Geometry to Frame Geometry

The mathematical procedure discussed below needs to be defined in such a way to accommodate bidirectional calculations to map the panel geometry onto the frame geometry required to make the panel, and also the reverse. For example, the frame geometry may need to be mapped onto the panel, such as where the frame has defined outer limits of movement which place constraints on the available panel shapes. Thus, the same process can be used to go from frame to panel and also from panel to frame. The process is the same, merely the edge length changes in the calculations.

FIG. 15B also shows the limits of skew and beta for the current prototype forming apparatus 10.

C. Mathematical Procedure to Describe any Hyperbolic Paraboloid Surface for Frame Mapping

The mathematical procedure to describe the hyperbolic paraboloid surface was created through defining an edge length for a square then translating that simple shape into a skewed hyperbolic paraboloid surface. The process of translating the square into a hyperbolic paraboloid requires three steps each with their respective descriptive parameters.

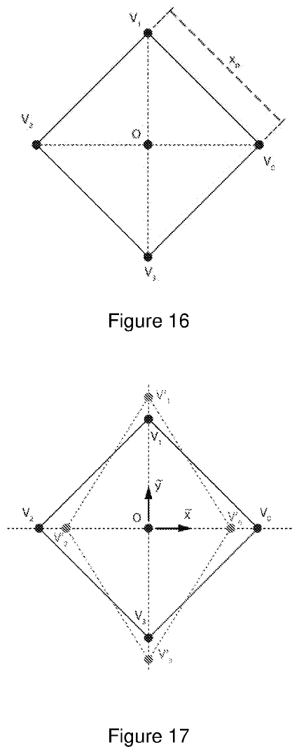

Step 1: Define a square with a chosen edge length (x), (FIG. 16).

xₚ= [symbol] = [symbol] = [symbol] =

[symbol]

The origin is defined as the mid-point between V₀ and V₂

O=½(V₀+V₂)

where V₀ and V₂ (and subsequently V₁ and V₃) are defined in a coordinate system.

Step 2: Skew the square using the skew parameter (α), (FIG. 17).

$$α = \frac{\vert \vec{{OV}_{0}^{′}} \vert}{\vert \vec{{OV}_{0}} \vert}$$

Where the vertices defined along the x-axis are simply scaled accordingly:

[symbol]

=

[symbol]

With symmetrical condition

[symbol]

=

[symbol]

Given the edge lengths must remain constant i.e.

x= [symbol] = [symbol] = [symbol] =

[symbol]

The translations of the vertices along the y-axis are found by the following:

$$\vec{{OV}_{1}^{′}} = {( {x}^{2} - {( α \vec{\vert {OV}_{0} \vert} )}^{2} )}^{\frac{1}{2}}$$

With symmetrical condition

[symbol]

=

[symbol]

Step 3: The vertices defined along the yz-plane are rotated (β) about the x-axis:

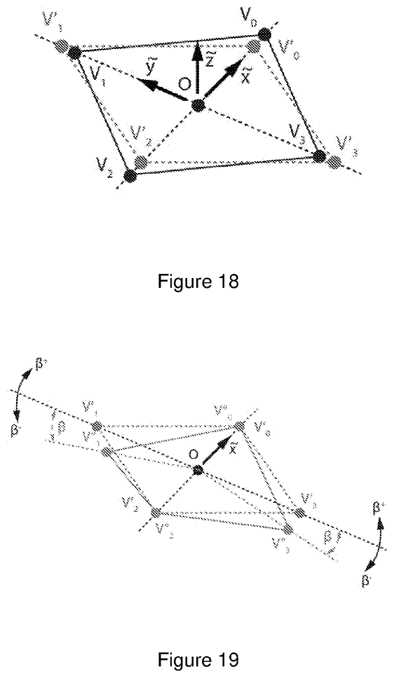

By firstly defining the Cartesian axes at O as in FIG. 18, the rotational translation about the x-axis was performed to resolve the definition of the hyperbolic paraboloid as in FIG. 19.

β= [symbol] ∠ [symbol] = [symbol] ∠

[symbol]

[symbol]

= [symbol] = [symbol] =

[symbol]

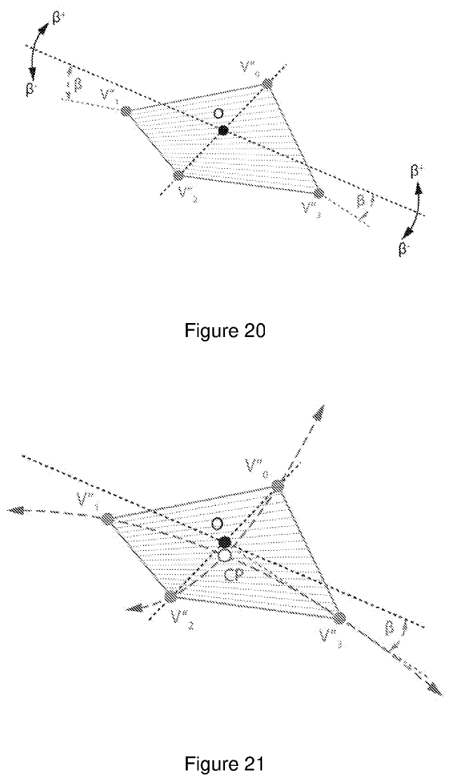

Rulings are then applied at increments from points along [symbol] to equivalent increments along [symbol] for the spacing between rulings required in FIG. 20.

That completes the process of determining the description of the hyperbolic paraboloid as defined by the three parameters (edge length (x), skew (α) and beta (β)).

Step (b)(iii) Calculate α and β for the Panel

Following on from step a) above, skew and beta can be calculated from the known vertices (V″₀, V″₁, V″₂, V″₃).

Fortunately, the three stage process described can also be reversed so that when a hyperbolic paraboloid surface is defined by its vertices, the edge-length, skew and beta parameters can be extracted from the surface. This is achieved as follows:

$$α = \frac{\sqrt{2} ⌈ \vec{{V}_{0}^{″} {V}_{2}^{″}} \vert}{2 {x}_{p}}$$

Where xₚ refers to the edge length of panel

O=½(V₀+V₂)

β= [symbol] ∠ [symbol] = [symbol] ∠

[symbol]

Beta can simply be solved using trigonometry.

3.5 Summary of Data Workflow

The summary of the data workflow is illustrated in FIG. 11.

This provides a consistent method of defining the hyperbolic paraboloids for the panel and the frame. The alpha, beta and edge length can be extracted from the panels located at various positions on the larger curved surface (FIG. 13) one wishes to fabricate.

This methodology allows for data extraction from a large very complex CAD model into individual panels that can be manufactured by the forming apparatus 10. By defining such panels simply by alpha, beta and edge length (step b), the panel geometry can be oriented relative to the variable frame geometry 14. Additionally, such simple panel definition allows a determination of whether the panel can be fabricated within the limits of the variable frame 14 as per FIG. 15B.

Once the panel geometry has been extracted as alpha, beta and edge length, it can be converted back to vertices information (V″₀, V″₁, V″₂, V″₃) to allow mapping of the panel vertices onto the required frame vertices V^{f}₀, V^{f}₁, V^{f}₂, V^{f}₃. (step c).

This simplified data extraction (as per step b) and a method to map each panel onto the frame (as per step c) allows separation of the two processes (steps b and c) from each other and furthermore separation of the steps b and c from the large very complex CAD model and thus provides an effective workflow from design to manufacture.

3.6 Step c) Translation of Panel Geometry to Frame Geometry

Overview

A method of translation between panel and parametric mould (and vice versa) is required.

It is desired to map a panel (as described above) with a defined edge length (x), skew (α) and beta (β) onto the hyperbolic paraboloid support 16 of the frame 14 to determine α′ and β′. However, the solution to the translation appears to be without a deterministic solution. Hence, an optimised curvature matching correction function was used to solve for the hyperbolic paraboloid translation.

The translation of panel geometry to frame geometry is done through curvature matching of scaled hyperbolic parabolas as will be described. In short, the parabolas extending between diagonally opposite vertices of the panel are extrapolated to estimate the location of the frame vertices, with the error resulting from the estimates being used to solve a quadratic correction function for the correct vertices of the frame.

Detailed Description of Translation of Panel Geometry to Frame Geometry

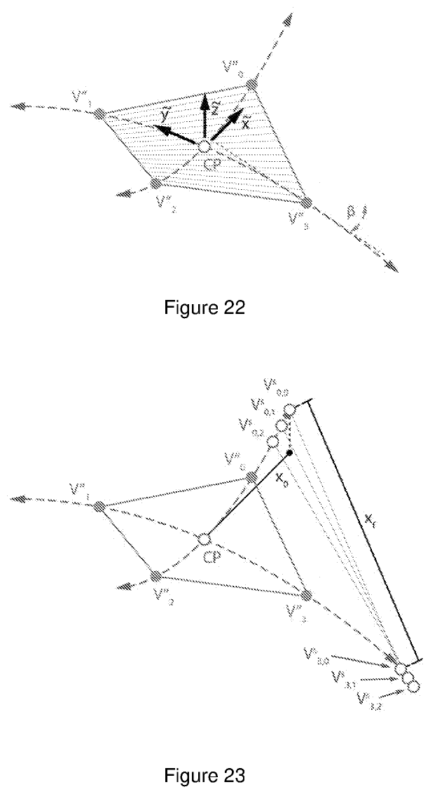

Referring to FIG. 22, the parabolas describing the curvature of the hyperbolic paraboloid surface are (for a Cartesian coordinate system located at CP):

CP=¼(V″₀+V″₁+V″₂+V″₃)
The xz plane parabola is: zₓ=aₓx²
The yz plane parabola is z_{y}=a_{y}y²

where aₓ and a_{y} can be determined from the location of the panel V″ vertices and CP point.

Three points V^{s}_{0,0}, V^{s}_{0,1}, V^{s}_{0,2} along the xz-plane parabola are chosen to formulate the curvature matching correction function. The location of the three points should be reasonable estimates of the vertices of frame 14, as per FIG. 23.

A spherical intersection between a sphere centred at each estimated vertex and the yz-plane parabola was performed to locate the vertices on the yz-plane parabola i.e. V^{s}_{3,0}; V^{s}_{3,1} and V^{s}_{3,2}—satisfying the frame equal edge length (x_{f}) criteria i.e.

x_{f}= [symbol] = [symbol] =

[symbol]

There are a number of different methods for spherical intersections. However using a direct algebraic method is the preferred method:

$${x}_{i}^{2} + {( {z}_{y} - {V}_{0 , z}^{″} )}^{2} \pm \frac{{z}_{y}}{{a}_{y}} = {x}_{f}^{2}$$

Where xᵢ was the i^{th} estimate of the xz-plane parabola abscissa where i=0,1,2.

Having now determined V^{s}_{0,0}, V^{s}_{0,1}, V^{s}_{0,2}, it is possible to directly derive V^{s}_{2,0}, V^{s}_{2,1}, V^{s}_{2,2}. Likewise, having determined V^{s}_{3,0}; V^{s}_{3,1} and V^{s}_{3,2}, it is possible to directly derive V^{s}_{1,0}; V^{s}_{1,1} and V^{s}_{1,2}.

Thus, 3 estimated frames are defined by this process, each having a respective centre point CP₁, CP₂, CP₃.

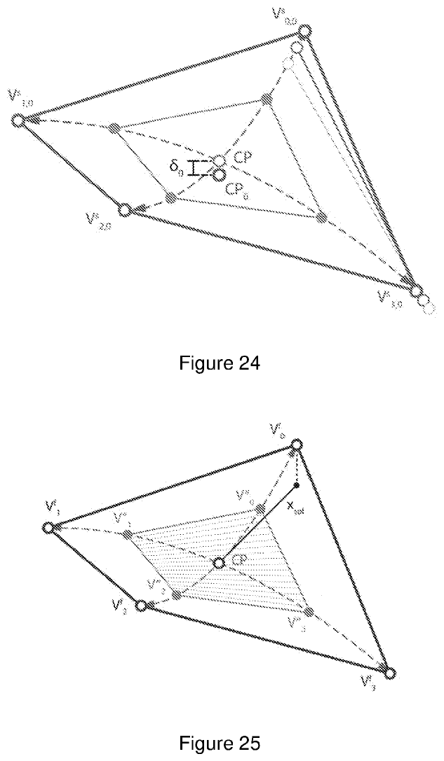

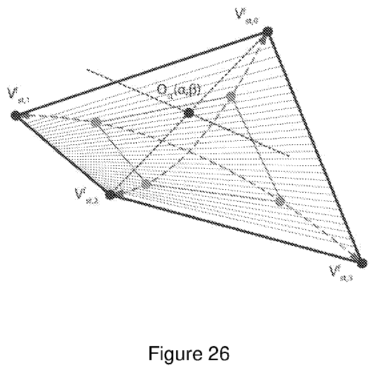

As per FIG. 24, the distances (δ₀, δ₁ and δ₂) between the centre-point of the panel and the centre point of the three estimated frames are defined:

δᵢ= [symbol] where i=0,1,2

A quadratic correction function relating the distance between the centre-points and the abscissa x₀, x₁ and x₂ of the three estimates along the parabola in the xz-plane was used to determine the abscissa xₛₒₗ of the correct location of the vertex V^{f}₀. The quadratic correction function takes the form:

δᵢ=axᵢ²+bxᵢ+c
where i=0, 1, 2

The coefficients a, b and c change values based on skew and beta states of the parametric mould. Hence, the coefficients needed to be solved very efficiently. A method to solve simultaneous equations using matrix inversions was used to solve the system of the three equations for a, b and c.

The solution of xₛₒₗ occurs when distance [symbol] is zero (δ=0). This is when the surface curvature described by the mould frame rulings will match the curvature of the panel. Thus:

0=axₛₒₗ²+bxₛₒₗ+c

Once xₛₒₗ was found—it was used to locate the first frame vertex solution on the xz-plane parabola, as FIG. 25.

z_{x,sol}=aₓxₛₒₗ²

V^{f}₀={xₛₒₗ,0,aₓxₛₒₗ²}=−V^{f}₂ where CP={0,0,0}

V^{f}₁ and V^{f}₃ can be found using the same sphere-parabola intersection technique required for finding xₛₒₗ.

Thus the frame vertices V^{f}₀, V^{f}₁, V^{f}₂, V^{f}₃ are determined by the above process.

The above modelling has been done with CP at the centre of the panel. However, in a global coordinate system, a change in β will result in a change in CP since the α and β actuators are fixed to the support structure of the apparatus 10. Therefore, when defining positions of the vertices within a global, static coordinate system, a slight vertical correction must be made to CP.

A suitable fixed origin is defined when the apparatus 10 was at its rest state i.e. when α=1 and β=0.

Oₛₜ(α,β)={0,0,0}=CP(1,0)

CP(α,β)={0,0,−aₓxₛₒₗ²}_{O}_{ₛₜ}

V^{f}_{st,i}=V^{f}ᵢ−{0,0,aₓxₛₒₗ²} for i=0,1,2,3

3.7 Step d) Calculate Target Travel Distances for the α and β Actuators

The actuator motion can be calculated from the frame vertices V^{f}₀, V^{f}₁, V^{f}₂, V^{f}₃.

The α actuators act symmetrically as do the β actuators. Therefore, only two coordinates are required to describe the positional state of the apparatus 10. This is further simplified with the gimbal 32 and tri-axial jointing systems 22 which maintain point singularities for rotational nodes. The actuation control system only requires two numerical values to operate the four linear actuators 26, 28, 29, 30.

All four actuators 26, 28, 29, 30 are able to act independently—they are not over-restrained—allowing for further simplification of the relative motion of each actuator during manipulations of the frame 14 that include the motion of all actuators at the same time. Each actuator does not need to move at a specific rate. Therefore, standard acceleration curves for actuator motion could be employed. The actuators 26, 28, 29, 30 act in such a way that each actuator will arrive at its target at the same time—even if the travel distances are different. Hence, the control system only requires the two target travel distances (α_{action}, β_{action}) to be mapped onto the four actuators.

By maintaining the point singularities at rotational joints where axes intersect, the derivation of the two numerical values for actuator motion is greatly simplified. The positioning of the actuators on the base of the static structural frame support for the apparatus 10 system is optimised for maximum actuator motion range.

The simplest version of the horizontal actuation system is two horizontal actuators acting symmetrically along the [symbol] axis which can be described by:

x_{hori,0}=V^{f}_{0,x}(α,β)−V^{f}_{0,x}(1,0)=−x_{hori,2}
where x_{hori,0} is the abscissa for V^{f}₀ and x_{hori,2} is the abscissa for V^{f}₂

However, we opted for a slanted configuration

$$( \frac{rise}{run} = \frac{3}{4} )$$

that solved both of these challenges. Giving a final sloped actuation target (α) calculated as (from the rest position where α=1 and β=0):

α_{action}=5/4x_{hori,0}

The beta actuator controls the degree of curvature of the frame 14.

For the beta actuator connected to V^{f}₁:

β_{st,1}={0,yₛₜ,zₛₜ}

and the beta actuator connected to V^{f}₃:

β_{st,3}={0,−yₛₜ,zₛₜ}

The beta actuation arm travel distance β_{action} relative to the rest position (α′=1 and β′=0) can be derived from the position of V^{f}_{st,1} or V^{f}_{st,3} (with vertical correction to compensate for the sloped alpha actuator):

$${β}_{action} = {( {( {V}_{st , 1 , y}^{f} ( α , β ) - {y}_{st} )}^{2} + {( {V}_{st , 1 , z}^{f} ( {α}_{,} β ) + \frac{3}{4} {x}_{h o r i , 0} + {z}_{st} )}^{2} )}^{\frac{1}{2}} - {( {( {V}_{st , 1 , y}^{f} ( 1 , 0 ) - {y}_{st} )}^{2} + {z}_{st}^{2} )}^{\frac{1}{2}}$$

The above methodology is incorporated into the control system which operates the forming apparatus 10.

It will be understood that the invention disclosed and defined in this specification extends to all alternative combinations of two or more of the individual features mentioned or evident from the text or drawings. All of these different combinations constitute various alternative aspects of the invention.

### 4 Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

For example, FIG. 27 is a block diagram that illustrates a computer system 600 upon which one or more steps described above may be implemented. Server computer 102 and/or user computer 112 may be computer systems such as 600.

Computer system 600 includes a bus 602 or other communication mechanism for communicating information, and a hardware processor 604 coupled with bus 602 for processing information. Hardware processor 604 may be, for example, a general purpose microprocessor.

Computer system 600 also includes a main memory 606, such as a random access memory (RAM) or other dynamic storage device, coupled to bus 602 for storing information and instructions to be executed by processor 604. Main memory 606 also may be used for storing temporary variables or other intermediate information during execution of instructions to be executed by processor 604. Such instructions, when stored in non-transitory storage media accessible to processor 604, render computer system 600 into a special-purpose machine that is customized to perform the operations specified in the instructions.

Computer system 600 further includes a read only memory (ROM) 608 or other static storage device coupled to bus 602 for storing static information and instructions for processor 604. A storage device 610, such as a magnetic disk or optical disk, is provided and coupled to bus 602 for storing information and instructions.

Computer system 600 may be coupled via bus 602 to one more output devices such as a display 612 for displaying information to a computer user. Display 612 may, for example, be a cathode ray tube (CRT), a liquid crystal display (LCD), a light emitting diode (LED display), or a touch screen display. An input device 614, including alphanumeric and other keys, may be coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane. Additional and/or alternative input devices are possible, for example touch screen displays.

Computer system 600 may implement the techniques described herein using customized hard-wired logic, one or more ASICs or FPGAs, firmware and/or program logic which in combination with the computer system causes or programs computer system 600 to be a special-purpose machine. According to one embodiment, the techniques herein are performed by computer system 600 in response to processor 604 executing one or more sequences of one or more instructions contained in main memory 606. Such instructions may be read into main memory 606 from another storage medium, such as storage device 610. Execution of the sequences of instructions contained in main memory 606 causes processor 604 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 610. Volatile media includes dynamic memory, such as main memory 606. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 602. Transmission media can also take the form of acoustic or light waves, such as those generated during radio-wave and infra-red data communications.

Various forms of media may be involved in carrying one or more sequences of one or more instructions to processor 604 for execution. For example, the instructions may initially be carried on a magnetic disk or solid state drive of a remote computer. The remote computer can load the instructions into its dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal and appropriate circuitry can place the data on bus 602. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 provides a two-way data communication coupling to a network link 620 that is connected to a local network 622. For example, communication interface 618 may be an integrated services digital network (ISDN) card, cable modem, satellite modem, or a modem to provide a data communication connection to a corresponding type of telephone line. As another example, communication interface 618 may be a local area network (LAN) card to provide a data communication connection to a compatible LAN. Wireless links may also be implemented. In any such implementation, communication interface 618 sends and receives electrical, electromagnetic or optical signals that carry digital data streams representing various types of information.

Network link 620 typically provides data communication through one or more networks to other data devices. For example, network link 620 may provide a connection through local network 622 to a host computer 624 or to data equipment operated by an Internet Service Provider (ISP) 626. ISP 626 in turn provides data communication services through the world wide packet data communication network now commonly referred to as the “Internet” 628. Local network 622 and Internet 628 both use electrical, electromagnetic or optical signals that carry digital data streams. The signals through the various networks and the signals on network link 620 and through communication interface 618, which carry the digital data to and from computer system 600, are example forms of transmission media.

Computer system 600 can send messages and receive data, including program code, through the network(s), network link 620 and communication interface 618. In the Internet example, a server 630 might transmit a requested code for an application program through Internet 628, ISP 626, local network 622 and communication interface 618.

The received code may be executed by processor 604 as it is received, and/or stored in storage device 610, or other non-volatile storage for later execution.

A computer system as described herein may be configured in a plurality of useful arrangements. In one approach, a data processing method comprises using a server computer, obtaining from one or more non-transitory computer-readable data storage media a copy of one or more sequences of instructions that are stored on the media and which when executed using a particular user computer among a plurality of user computers cause the particular user computer to perform, using the particular user computer alone or in combination with the server computer, the techniques that are described herein; and using the server computer, downloading the copy of the one or more sequences of instructions to any user computer among the plurality of user computers.

In another approach, a computer system comprises a server computer comprising one or more non-transitory computer-readable data storage media stored with one or more sequences of instructions which when executed using a particular user computer among a plurality of user computers cause the particular user computer to perform: using the particular user computer, alone or in combination with the server computer, the techniques that are described herein; and in the server computer, stored downloading instructions which, when executed using the server computer, cause downloading a plurality of copies of the one or more sequences of instructions to the plurality of user computers.

The foregoing describes only one embodiment of the present invention and modifications may be made thereto without departing from the scope of the invention.

### 5 References

Adapa (2017), ‘Adapa—Adaptive moulds’, www.adapa.dk. [Accessed 7 Sep. 2017]
Block, P. (2017), ‘Block Research Group’, www.block.arch.ethz.ch. [Accessed 7 Sep. 2017]
Block, P. (2016), ‘Paramet Structu Congeni’, Architectural Design, 68-70, John Wiley & Sons inc.
Burry, M. (2011), Scripting Cultures: Architectural Design and Programming, John Wiley & Sons inc.
Castañeda, E.; Lauret, B.; Lirola, J. M. & Ovando, G. (2015), ‘Free-form architectural envelopes: Digital processes opportunities of industrial production at a reasonable price’, Journal of Facade Design and Engineering 3(1), 1B [symbol] ″13.
Farshad, M. (2013), Design and Analysis of Shell Structures, Springer Netherlands.
Gardiner, J. B.; Janssen & Steven, R.McGee, W. & Ponce de Leon, M., ed., (2014), FreeFab, Springer International Publishing, Cham, pp. 131-146.
IBIS (2017), ‘Electrical Equipment and Machinery Manufacturing in China’ (C2034), Technical report, IBIS World Industry Report.
Kelly, A. (2016), ‘Concrete Product Manufacturing in Australia’ (C2034), Technical report, IBIS World Industry Report.
de Lagrange, F. (2016), ‘Geometrical Conoids String Surface Model’, in London Science Museum Group Online Collection. [Accessed 7 Jan. 2016]
Lavery, C. (2013), ‘Spencer Dock Bridge’, Concrete International June, 28-31.
Lee, G. & Kim, S. (2012), ‘Case Study of Mass Customization of Double-Curved Metal Façade Panels Using a New Hybrid Sheet Metal Processing Technique’, Journal of Construction Engineering and Management 138.
O'Rouke, L. (2017), ‘FreeFAB’. www.freefab.com [Accessed 7 Jan. 2016]
Oesterle, S.; Vansteenkiste, A.; Gramazio, F. & Kohler, M. (2012), ‘Method for on-site casting of free-form concrete structures’ (EP2532808 A1).
Pottman, H.; Asperl, A.; Hofer, M. & Kilian, A. (2007), Architectural Geometry, Bentley Institute Press.
Scheurer, F. (2010), ‘Materialising Complexity’, Architectural Design, 86-91, John Wiley & Sons inc.
Schipper, H. R. (2015), ‘Double-curved precast concrete elements’, PhD thesis, Technische Universiteit Delft.
Verma, S. & Epps, G. (2013), ‘Curved Folding: Design to Production’, ACADIA, Adaptive Architecture.
Wang, S.; Cai, Z.; Li, M. & Lan, Y. (2012), ‘Numerical simulation on the local stress and local deformation in multi-point stretch forming process’, The International Journal of Advanced Manufacturing Technology 60(9), 901-911.

1. A variable shaping form including:
a variable frame; and
a variable support extending within or across the frame,
wherein the shaping form is selectively adjustable to vary the shape of the support to define a variety of differently shaped contours, each of which approximates a doubly-ruled curved surface.

2. The variable shaping form as claimed in claim 1 wherein the doubly-ruled curved surface is a hyperbolic paraboloid.

3. The variable shaping form as claimed in claim 2 wherein the variable frame is four-sided and of equal side lengths such that the doubly-ruled curved surface is a rhombus hyperbolic paraboloid.

4. The variable shaping form as claimed in claim 1 wherein the variable frame comprises a plurality of frame portions which have any one or more of the following features: straight rods or bars; fixed i.e. non-variable length; all frame portions are of equal length; 4 frame portions; adjacent frame portions are relatively pivotable; adjacent frame portions are either interconnected or discrete.

5. The variable shaping form as claimed in claim 1 wherein adjacent frame portions are pivotally interconnected with a multi-axial joint.

6. (canceled)

7. The variable shaping form as claimed in claim 1 wherein the variable support is defined by a series of spaced rods or bars extending between two opposite frame portions.

8.-10. (canceled)

11. A variable shaping form including:
a variable frame defined by a plurality of frame portions; and
a variable support extending within or across the frame,
wherein the frame portions are selectively relatively moveable to vary the shape of the support to define a variety of differently shaped contours.

12. The variable shaping form as claimed in claim 11 wherein the variable frame is four-sided and of equal side lengths to define a rhombic frame.

13. The variable shaping form as claimed in claim 11 wherein the plurality of frame portions have any one or more of the following features: straight rods or bars; fixed i.e. non-variable length; all frame portions are of equal length; adjacent frame portions are relatively pivotable; and adjacent frame portions are either interconnected or discrete.

14. The variable shaping form as claimed in claim 11 wherein adjacent frame portions are pivotally interconnected with a multi-axial joint.

15. (canceled)

16. The variable shaping form as claimed in claim 11 wherein the variable support is defined by a series of spaced rods or bars extending between two opposite frame portions.

17.-19. (canceled)

20. A method of shaping formable material, the method including:
a) providing a variable shaping form as claimed in any one of claims 1 to 19;
b) adjusting the variable shaping form such that the variable support defines a desired contour;
c) either before or after step b, supporting the formable material on the variable support;
d) allowing the formable material to fully or partially set or cure to substantially conform to the desired contour of the variable support; and
e) removing the formable material from the variable shaping form.

21. The method as claimed in claim 20 further comprising a batch process of repeating steps b) to e) with the same selected contour or a different selected contour.

22.-25. (canceled)

26. A forming apparatus including:
a variable shaping form as claimed in any one of claims 1 to 19;
a support apparatus to adjust the variable shaping form, wherein the support apparatus includes a motorized adjustment mechanism.

27. (canceled)

28. The forming apparatus as claimed in claim 27 further including a control system to receive configuration data for the variable shaping form, wherein the control system controls the motorized adjustment mechanism to conform the variable frame in response to the configuration data.

29. The forming apparatus as claimed in claim 28 wherein adjustment of the variable frame is driven from the vertices of the variable frame.

30. The forming apparatus as claimed in claim 29 wherein there is one adjustment actuator for each vertex for the variable frame.

31. The forming apparatus as claimed in claim 30 wherein diagonally opposite first frame vertices are associated with respective actuators (α actuators) to adjust skew of the variable frame while diagonally opposite second frame vertices are associated with respective actuators (β actuators) to adjust the fold angle (beta) about an axis through the first frame vertices.

32. (canceled)

33. The forming apparatus as claimed in claim 31 wherein each β actuator is connected to the associated vertex in a manner which allows for intersection of the longitudinal axis of the actuator and two adjacent frame portions at a single point.

34.-59. (canceled)

60. A formed part when formed using the apparatus of claim 1.

61. A formed part when using the apparatus of claim 11.
